(19) United States
(12) Patent Application Publication
(10) Pub. No.: US 2014/0190333 A1
(43) Pub. Date: Jul. 10, 2014

(54) Magnetic Musical Drum Suspension System

(71) Applicant: Kenneth Howard Sams, Sparaway, WA (US)

(72) Inventor: Kenneth Howard Sams, Sparaway, WA (US)

(21) Appl. No.: 14/093,031

(22) Filed: Nov. 28, 2013

Related U.S. Application Data
(60) Provisional application No. 61/848,728, filed on Jan. 9, 2013.

(51) Int. Cl. G10D 13/02

(52) U.S. Cl. CPC G10D 13/02
USPC 84/419

(57) ABSTRACT

A magnetic system supports an acoustic drum vertically and radially with respect to a support structure such as a drum stand.

### TECHNICAL FIELD

This invention pertains to the field of musical instruments. More specifically, the invention relates to methods and apparatus for improving reverberation in acoustic drums.

### BACKGROUND OF THE INVENTION

Commonly used acoustic drums utilize a membrane stretched over an open ended cylindrical body such as in a tom tom drum. A percussive strike on the membrane causes the drum to resonate. Commutation of the drum body resonance to the air creates sound waves which are heard by a listener. The air also damps the drum vibrations. Mechanical supports on the drum, such as a drum arm connected to a drum stand further damp and thus disadvantageously limit the drum reverberations.

### BRIEF SUMMARY OF THE INVENTION

It is therefore an object of the present invention to provide for an acoustic drum with reduced reverberation dampening.

It is a further object of the present invention to provide for an acoustic drum which achieves the above object and which also is adaptable to conventional acoustic drums.

It is yet another object of the present invention to provide for an acoustic drum which achieves the above objects and which also mechanically decouples the drum from a support device such as a stand.

The invention achieves the above objects, and other objects and advantages which will become apparent from the description which follows, by providing a conventional drum with a system of magnets that isolate the drum vertically and radially with respect to a support frame.

In the preferred embodiments of the invention, the magnetically supported drum is provided with magnets in cooperation with conventional lugs to magnetically isolate the drum vertically and radially. This invention solves the problem found on all current drums sets by suspending the drum without the use of an arm attached to the drum.

### BRIEF DESCRIPTION OF THE DRAWINGS

FIG. 1 is one complete unit in which there are usually five to 10 units on one drum.

FIG. 2 is the drum lug.

FIG. 3 is the floating rod and receiver.

FIG. 4 is a view into the end of the floating receiver which receives the lug.

FIG. 5 is a view of the end of the lug which inserts into the floating receiver.

FIG. 6 is an angled view of the floating rod and receivers.

FIG. 7 is an angled view of the lug and its magnet assembly.

### DETAILED DESCRIPTION OF THE PREFERRED EMBODIMENTS

A magnetically supported acoustic drum in accordance with the principles of the invention is generally indicated at reference numeral 14 in the various figures of the attached drawings wherein numbered elements in the figures correspond to the like numbered elements herein.

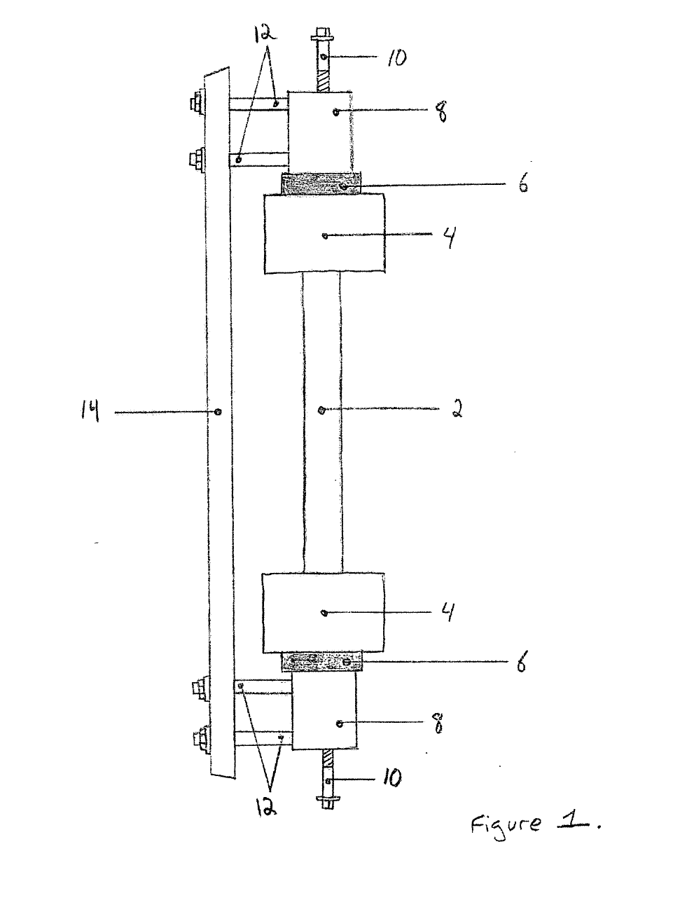

FIG. 1. 2. is the floating rod that houses rod magnets 18. 2. attaches to 4. which houses inward firing arc magnets 16. 4 receives 8. which has 6. on the end of it. 6. fires outward in all directions via a set of four arc magnets. In the middle of 6 is rod magnet 20 which fires downward towards magnet 18 which in turn is firing upwards towards rod magnet 20. When 8 is slipped into 4 the four opposing forces of the magnets acting on each other will allow 2. and 4. to float in mid-air. 2. and 4. are fitted together to make one solid piece. 10. is the drums tension bolt which is used to tune the drum head. 12. are the lugs bolts which attach the lug to the drum shell. 14. is a cutaway of the drum shell. 2. will have a metal band attached to it which traverses the circumference of the drum. This metal band would be fastened to all of the units, on the drum by means of 2. A tom arm or drum leg would then be attached to the metal band.

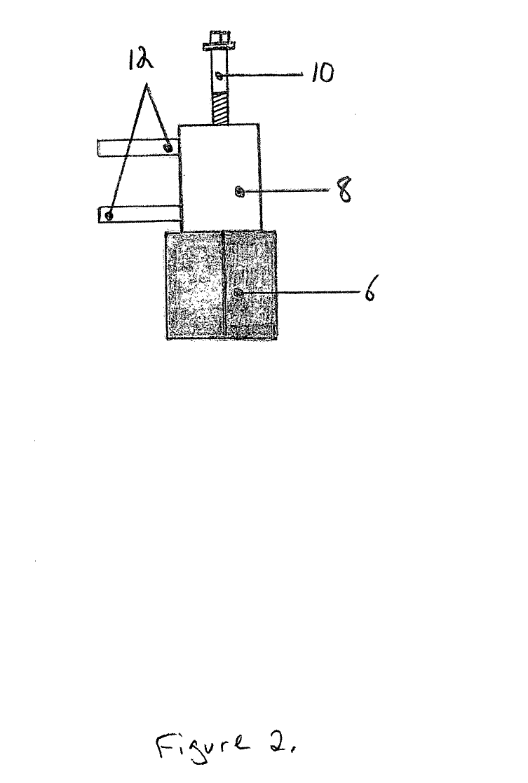

FIG. 2. 8. is the drum lug. 6. is a set of arc magnets that circle the end of 8. 6. fires outwards in all directions.

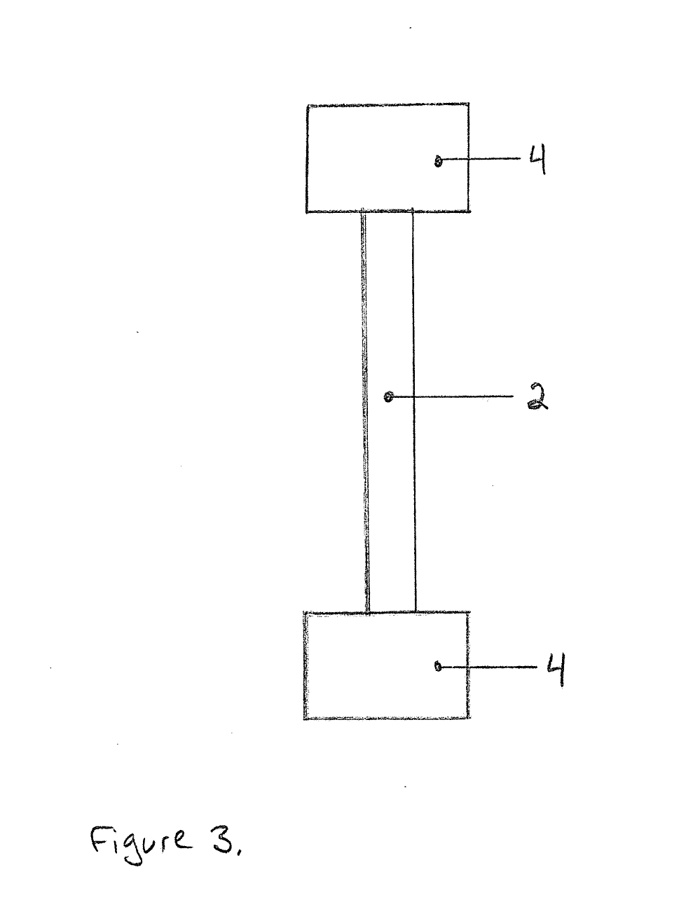

FIG. 3. FIG. 3. is the floating rod 2. and receivers 4.

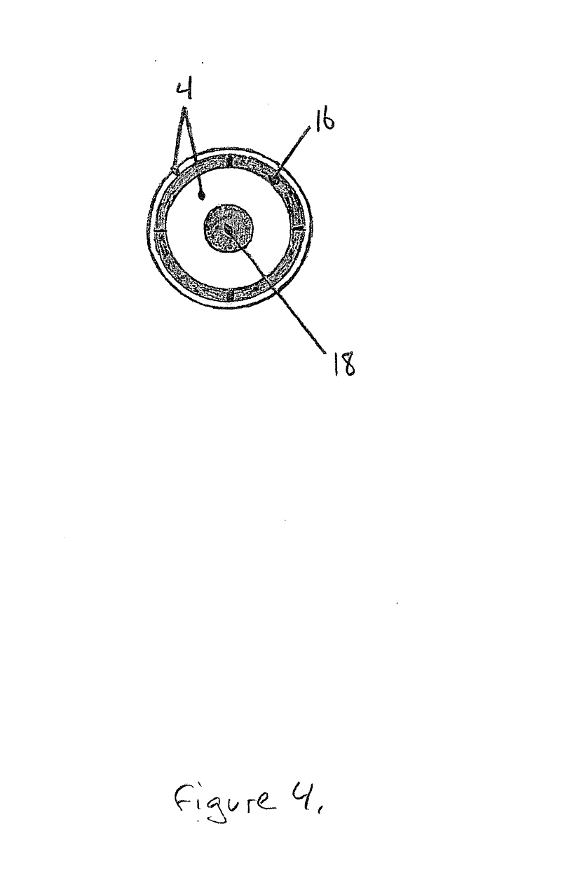

FIG. 4. 4. is the housing for the receiver which houses inward firing arc magnets 16. 18. is a rod magnet that is housed in both ends of the floating rod. 18. fires upwards towards magnet 20. which is housed in the end of the drum lug 8.

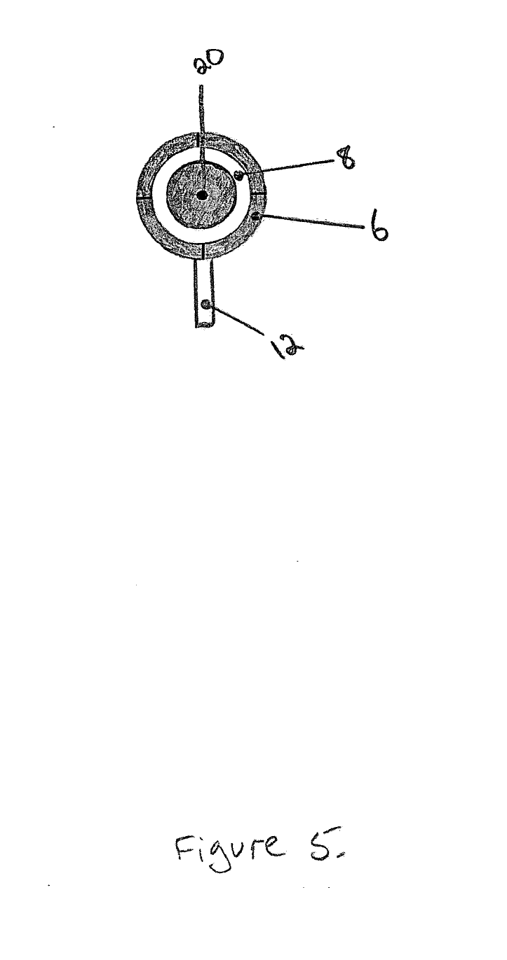

FIG. 5. 8 is the drum lug which houses rod magnet 20 which fires downward toward magnet 18. 6. is a set of arc magnets that fire outwards in all directions towards arc magnets 16. 12 is the bolts which are used to attach the lug to the drum shell.

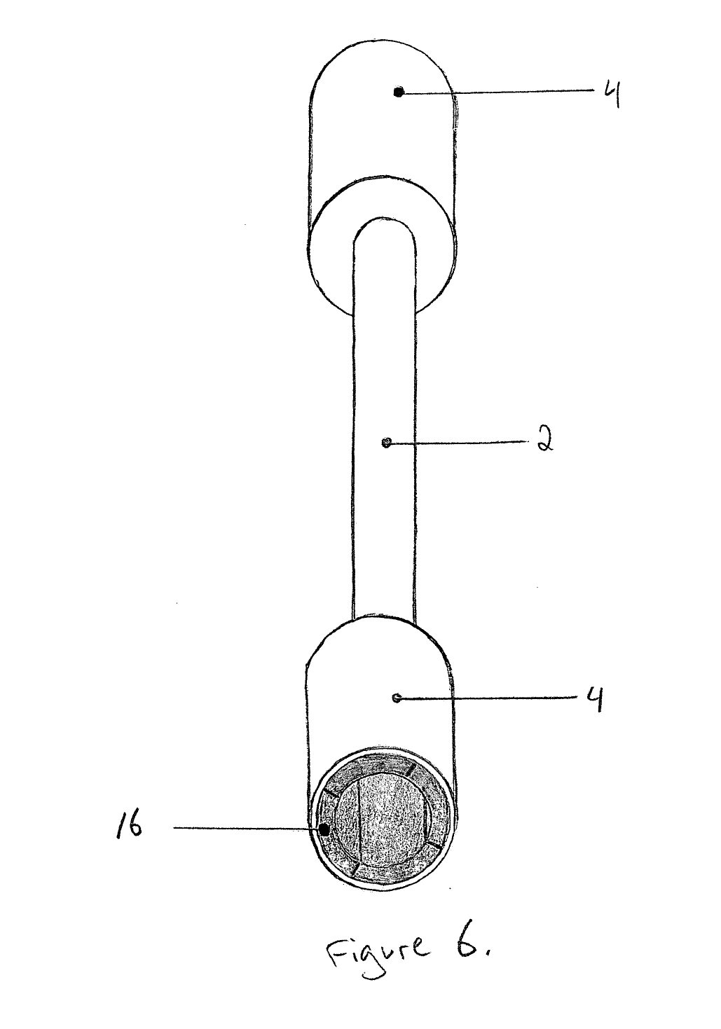

FIG. 6. 2. is the floating rod which houses two rod magnets which are fitted in each end of it near receivers 4. 4. is the floating receiver which houses arc magnets 16. 16. are arc magnets which fire inward from all directions. The floating rod 2. and receivers 4. are fitted to each other as to be one solid piece.

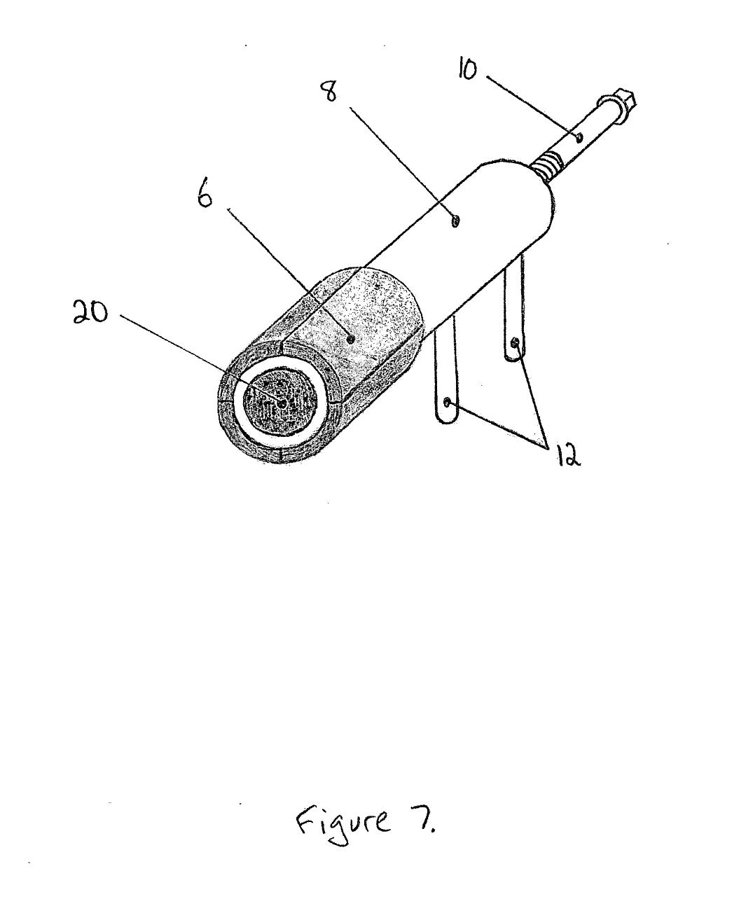

FIG. 7. 8. is the drum lug. 10. is the tension rod which is used to tune the drum head. 12. are the bolts used to fasten the lug to the drum shell. 6. are a set of arc magnets which fire outwards in all directions. When 6. is slipped into floating receiver 4. the opposing forces of magnets 6. and 16 acting on each other would provide horizontal support for the drum once the unit was assembled and mounted to a drum stand or drum legs. 20. is a rod magnet which fires downwards towards rod magnet 18. The opposing forces of magnets 20. and 18. would allow the drum to float vertically and provide vertical support for the drum once the unit was assembled and attached to a drum stand or drum legs.

Those of ordinary skill in the art will conceive of other alternate embodiments of the invention upon reviewing this disclosure. Thus, the invention is not to be limited to the above description, but is to be determined in scope by the claims which follow.

The objects of this invention are to maximize the quality of tone of a musical drum beyond what is currently available to the public. The invention achieves this and other objectives and advantages which will become apparent from the following description by providing maximum quality tone from a musical drum by eliminating the need to use an attached arm which would choke the tone of a musical drum.

I claim:

1. A magnetic acoustic drum suspension system, comprising:
an acoustic drum having a resonating annular hollow body having a plurality of open ends and a tympanic membrane held in tension over one of the ends;
means for magnetically supporting the body radially and vertically with respect to a support structure to maximize sustain of the drum.
